(19) United States
(12) Patent Application Publication
(10) Pub. No.: US 2026/0250166 A1
(43) Pub. Date: Aug. 27, 2026

(54) VISIBLE-LIGHT SEMICONDUCTOR HETEROSTRUCTURE FOR POLYFLUOROALKYL SUBSTANCES (PFAS) DEGRADATION

(71) Applicant: University of Central Florida Research Foundation, Inc., Orlando, FL (US)

(72) Inventors: Ni-Bin Chang, Orlando, FL (US); A H M Anwar Sadmani, Orlando, FL (US); Md Touhidul Islam, Orlando, FL (US)

(21) Appl. No.: 19/453,508

(22) Filed: Jan. 20, 2026

Related U.S. Application Data
(60) Provisional application No. 63/763,384, filed on Feb. 26, 2025.

(51) Int. Cl. C02F 1/72; C02F 1/28; C02F 1/30; C02F 101/36

(52) U.S. Cl. CPC C02F 1/725; C02F 1/288; C02F 1/30; C02F 2101/36; C02F 2305/023; C02F 2305/10

(57) ABSTRACT

Per-and polyfluoroalkyl substances (PFAS) are persistent contaminants that pose significant environmental and health risks. This invention introduces a semiconductor heterostructure material under visible light for PFAS degradation in aqueous matrices. Utilizing hexagonal boron nitride (h-BN) and zirconium dioxide (ZrO₂), the heterostructure enhances charge separation and light absorption, enabling efficient PFAS mineralization under visible light. The invention offers a cost-effective and sustainable solution for PFAS remediation in wastewater treatment, stormwater management, and industrial effluents. By destroying rather than removing PFAS, the heterostructure provides a transformative advancement in environmental cleanup.

### CROSS-REFERENCE TO RELATED APPLICATIONS

This Nonprovisional Patent Application claims the benefit of and priority to U.S. Provisional Patent Application No. 63/763,384 entitled “VISIBLE-LIGHT SEMICONDUCTOR HETEROSTRUCTURE FOR POLYFLUOROALKYL SUBSTANCES (PFAS) DEGRADATION” filed Feb. 26, 2025, by the same inventors, all of which is incorporated herein by reference, in its entirety, for all purposes.

### BACKGROUND OF THE INVENTION

Per-and polyfluoroalkyl substances (PFAS) are a class of synthetic chemicals that are widely used in industrial applications and consumer products due to their unique properties, including high thermal stability, resistance to degradation, and hydrophobicity. However, these very characteristics have contributed to their persistence and accumulation in the environment, earning them the label of “forever chemicals”.

PFAS contamination in surface water and groundwater poses significant health risks, as prolonged exposure has been linked to adverse outcomes including cancer, endocrine disruption, and immune system impairment. This issue underscores the urgent need to develop effective remediation technologies capable of separating and degrading PFAS in a cost-effective and sustainable manner.

Conventional water treatment methods, such as filtration and adsorption, often fall short of fully eliminating PFAS from the environment, as they typically transfer contaminants rather than degrade them. In recent years, advanced oxidation processes (AOPs), especially photocatalysis, have gained attention as promising strategies for PFAS degradation due to their ability to directly mineralize persistent pollutants into nontoxic byproducts using light-driven reactions. However, challenges such as low quantum efficiency, limited visible light absorption, and rapid charge carrier recombination hinder the widespread adoption of photocatalytic systems for large-scale PFAS treatment.

Accordingly, what is needed is a readily scalable, energy-efficient approach capable of degrading PFAS directly in contaminated aqueous matrices, thereby overcoming the existing reliance on high-cost UV systems, minimizing secondary waste streams, and ensuring thorough mineralization without generating further environmental hazards. However, considering the state of the art at the time this invention was developed, it was not apparent to those skilled in the field how the limitations of prior technologies could be effectively addressed.

### BRIEF SUMMARY OF THE INVENTION

The present invention provides a composition, apparatus, and method for the photocatalytic degradation of per-and polyfluoroalkyl substances (PFAS) in contaminated aqueous matrices under visible light. In various embodiments, the apparatus comprises a stacked semiconductor heterostructure designed to facilitate visible-light-driven photocatalysis. The semiconductor heterostructure includes a semiconductor layer of hexagonal boron nitride (h-BN) and a semiconductor layer of zirconium dioxide (ZrO₂). A light source emitting visible light activates the semiconductor heterostructure, promoting charge carrier generation for PFAS degradation. The system further comprises a reaction chamber containing the contaminated aqueous matrix, ensuring optimal interaction between the PFAS molecules and the semiconductor heterostructure. In certain embodiments, the h-BN and ZrO₂ layers form a Type-II heterojunction, which enhances electron-hole pair separation and suppresses charge recombination, thereby improving photocatalytic efficiency. The reaction chamber may also include a circulation system to ensure uniform exposure of the contaminated water to the photocatalyst, thereby enhancing degradation efficiency.

In additional embodiments, the apparatus may include a pre-treatment unit for concentrating PFAS from the water before photocatalytic degradation, which allows for more effective removal of low-concentration contaminants. The light source operates within a wavelength range of about 400 nm to about 700 nm, optimizing energy absorption and reaction efficiency. A post-treatment filtration system may also be included to capture residual degradation byproducts, ensuring that treated water meets safety standards before discharge.

The invention further provides a semiconductor heterostructure composition specifically optimized for visible-light photocatalysis. The heterostructure comprises h-BN and ZrO₂, engineered to enhance charge separation and suppress charge recombination, thus facilitating efficient PFAS degradation. In certain embodiments, the heterostructure exhibits a bandgap of approximately 1.33 eV, allowing for strong visible-light absorption and activation. The h-BN and ZrO₂ layers may be arranged in a layered or co-doped configuration to further improve interfacial charge transfer. The heterostructure may be synthesized using a quantum virtual laboratory (QVL) approach, enabling precise optimization of material selection, band alignment, and photocatalytic properties. Additionally, the heterostructure exhibits high electron affinity (greater than 6.5 eV), which enhances hole oxidation and promotes effective PFAS degradation. In some embodiments, the heterostructure may include doping elements to further improve charge carrier mobility and overall photocatalytic efficiency.

The invention also provides a method for degrading PFAS in a contaminated aqueous matrix using the h-BN/ZrO₂ heterostructure. The method comprises introducing the semiconductor heterostructure into the contaminated aqueous matrix and exposing it to visible light, which generates electron-hole pairs that drive oxidation and reduction reactions at the heterostructure interface. The method facilitates redox reactions, leading to the formation of reactive oxygen species (ROS), which interact with PFAS molecules, promoting adsorption onto the semiconductor surface. The adsorbed PFAS molecules subsequently undergo defluorination and mineralization, breaking down into non-toxic byproducts, such as fluoride ions and carbon-based fragments. The process further includes removing residual degradation byproducts to ensure that the treated water is free of harmful contaminants.

In certain embodiments, the visible-light source operates within a wavelength range of about 400 nm to about 700 nm to ensure optimal PFAS degradation. The semiconductor heterostructure is designed to exhibit a Type-II heterojunction, which improves charge separation efficiency and extends charge carrier lifetimes, thereby increasing overall photocatalytic activity. The method may also involve computational modeling techniques, including density functional theory (DFT) simulations and QVL modeling, to optimize heterostructure design for maximum degradation efficiency. In additional embodiments, the method includes pre-concentrating PFAS in the water matrix using ion exchange, foam fractionation, or membrane filtration before photocatalysis to improve removal efficiency. The effectiveness of the degradation process may be enhanced by modifying the surface morphology of the heterostructure, which improves PFAS adsorption and accelerates reaction kinetics. To ensure complete detoxification, the method may further include secondary treatment methods, such as biological oxidation, activated carbon adsorption, or electrochemical reduction, to process degradation byproducts and prevent the formation of secondary contaminants.

This invention provides a highly efficient, energy-sustainable, and scalable solution for PFAS degradation, overcoming the limitations of conventional treatment methods. By leveraging visible-light-driven photocatalysis, enhanced charge separation, and advanced material engineering, the invention facilitates complete mineralization of PFAS while minimizing operational costs and environmental impact.

These and other important objectives, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a band energy diagram comparing conduction and valence band positions of semiconductor materials relative to vacuum level.

FIG. 2 is an energy landscape showing free radical generation from water across different semiconductors.

FIG. 3A is an energy landscape for perfluorooctanoic acid (PFOA) decarboxylation across four semiconductors.

FIG. 3B is an energy landscape for PFOA defluorination across four semiconductors. FIG. 4A is a band structure and density of states (DOS) plot for h-BN.

FIG. 4B is a band structure and density of states (DOS) plot for ZrO₂.

FIG. 5A is a schematic of h-BN/ZrO₂ heterostructure promoting electron-hole separation for PFAS degradation.

FIG. 5B is an electrostatic potential difference plot at the semiconductor interface.

FIG. 6A is a visualization of highest occupied molecular orbital (HOMO) and LUMO highest occupied molecular orbital (LUMO) for PFAS molecules.

FIG. 6B is a visualization of Fukui functions for nucleophilic, electrophilic, and free radical attack on PFAS molecules.

FIG. 7A is an energy landscape showing stepwise PFOA defluorination on ZrO₂.

FIG. 7B is a molecular orbital diagram of PFOA adsorption on ZrO₂.

FIG. 7C is an isosurface plot of electron density distribution in the initial adsorbed state of PFOA on ZrO₂.

FIG. 7D is an isosurface plot of electron density distribution after complete PFOA defluorination on ZrO₂.

FIG. 8A is a UV-VIS absorption spectrum of ZrO₂.

FIG. 8B is a UV-VIS absorption spectrum of the ZrO₂/h-BN heterostructure.

FIG. 8C is a molecular orbital diagram of PFOA interacting with bulk ZrO₂.

FIG. 8D is a molecular orbital diagram of PFOA interacting with the ZrO₂/h-BN heterostructure.

FIG. 8E is an electron density transfer visualization from HOMO to LUMO in PFOA-ZrO₂ interaction.

FIG. 8F is an electron density transfer visualization from HOMO to LUMO in PFOA-ZrO₂/h-BN interaction.

FIG. 9 illustrates a table showing semiconductor materials evaluated for photocatalytic PFAS degradation.

### DETAILED DESCRIPTION OF THE INVENTION

Semiconductor heterostructures, comprising two or more semiconductors with complementary properties, represent an innovative approach to enhancing photocatalytic efficiency when destructing the highly concentrated PFAS from conventional removal processes such as ion exchange, membrane, activated carbon adsorption, and foam fractionation processes. By optimizing charge separation and reducing recombination losses, some of these heterostructures offer improved photodegradation performance under visible light. In photocatalytic systems, a semiconductor material absorbs photons from a light source, typically in the ultraviolet (UV) or visible spectrum, generating electron-hole pairs. These charge carriers initiate redox reactions that produce highly reactive species such as hydroxyl radicals (·OH) and superoxide radicals (·O₂-), which can attack and degrade even the most recalcitrant pollutants, including PFAS. Nevertheless, the widespread adoption of photocatalytic systems for large-scale PFAS treatment is challenged by low quantum efficiency, limited absorption of visible light resulting in increased cost, and rapid recombination of charge carriers.

In various embodiments, the present invention provides for the use of semiconductor heterostructures for the photocatalytic degradation of PFAS by a quantum virtual laboratory (QVL) approach, based on their synthesis potential, mechanisms of destruction, and the factors influencing their activity. The goal is to assess the viability of semiconductor heterostructures with the aid of quantum chemistry theory as a scalable solution for eliminating, rather than merely adsorbing, PFAS in pollution control, offering a pathway toward cleaner and safer water matrices.

Semiconductor heterostructures offer an innovative solution to the challenges associated with photocatalytic degradation by combining two or more semiconductors with complementary electronic properties, thereby enhancing overall photocatalytic efficiency. These heterostructures are designed to improve charge separation and minimize recombination losses through stepwise band alignment, facilitating efficient electron transfer. When exposed to visible light, the heterostructures absorb a broader range of the solar spectrum, generating more electron-hole pairs and increasing the generation of reactive species. This is because electron-hole pairs are important for determining the electrical and optical properties of quantum dots or semiconductor nanocrystals. Moreover, heterostructures can be tailored to optimize other key factors such as surface area, light absorption, and photocatalytic stability, all of which contribute to the degradation of PFAS molecules. In this invention, a QVL approach is provided to simulate fifteen potential semiconductor material pairs, aiming to identify the optimal semiconductor heterostructures for enhanced photocatalytic degradation of PFAS under visible light, which is a novel approach that has not been previously explored. The removal mechanisms associated with a suite of semiconductors is investigated to identify the most effective material for defluorination, rather than decarboxylation, during the photocatalytic process.

Multicriteria screening of semiconductor materials through virtual experimentation in QVL has been carried out because semiconductor photocatalysts have attracted significant attention in recent years due to their potential in solar-driven processes such as visible light photocatalysis. However, their effectiveness depends on various critical material properties that influence their overall performance. Here, a multicriteria decision making (MCDM) approach has been adopted, namely the Technique for Order Preference by Similarity to Ideal Solution (TOPSIS), to screen and rank semiconductor photocatalysts based on a few intrinsic criteria. Six criteria were selected for the evaluation process, including band gap, absorbance at the lowest visible light spectrum (413 nm), recombination, electron mobility, electron density, and the offset between valence band edge and water oxidation potential. Since the study focuses on utilizing visible light, the absorbance only within the visible light spectrum was considered. These criteria were assigned weights according to their relative importance in determining overall photocatalytic performance, with particular emphasis on optimizing the balance between effective charge separation and visible light absorption. Each semiconductor candidate was assessed using normalized data to ensure comparability across different scales. Before performing TOPSIS analysis, it was crucial to ensure that the input variables were independent of one another. In MCDM problems, the presence of multicollinearity, wherein two or more predictor variables are highly correlated, can distort the results by disproportionately emphasizing specific criteria. Such distortions can mislead the decision-making process, resulting in overestimation or underestimation of certain variables. In this study, a multicollinearity analysis was performed to address this issue.

In the context of semiconductor photocatalysts, performance criteria such as band gap, absorbance, recombination rates, electron mobility, electron density, hole mobility, and hole density are likely to exhibit some level of interdependence. The TOPSIS analysis was applied to fifteen semiconductor materials, encompassing both traditional metal oxides and more novel materials that have not yet been examined elsewhere. Within the framework of TOPSIS, the ideal candidate was defined as the material exhibiting the closest distance to the positive ideal solution and the farthest distance from the negative ideal solution simultaneously, based on all evaluated criteria.

The final ranking of materials was determined based on their relative measures to the two ideal solutions. The ideal solution exhibits a band gap of 0.04466 eV, an absorbance of 509,320 cm⁻¹, a recombination rate of 0.145, electron mobility of 1.19 cm²/V·s, an electron density of 7,070 cm⁻³, an electron affinity of 6.75 eV, and a valence band offset of 4.733 eV. The findings indicate that materials with moderate band gaps, high absorbance, and low recombination rates were ranked the highest. Furthermore, materials with a high valence band offset were prioritized. Given that PFAS degradation is predominantly driven by the hole oxidation mechanism, maximizing the valence band offset was a key objective. Additionally, to enhance the interaction between the semiconductor material and PFAS, electron affinity was prioritized in the TOPSIS analysis. Consequently, semiconductors optimized for hydrogen evolution reactions or characterized by high electron density were not favored. Conversely, wide band semiconductors with moderate electron affinity such as ZrO₂, SnO₂, BN, and TiO₂ were ranked highly.

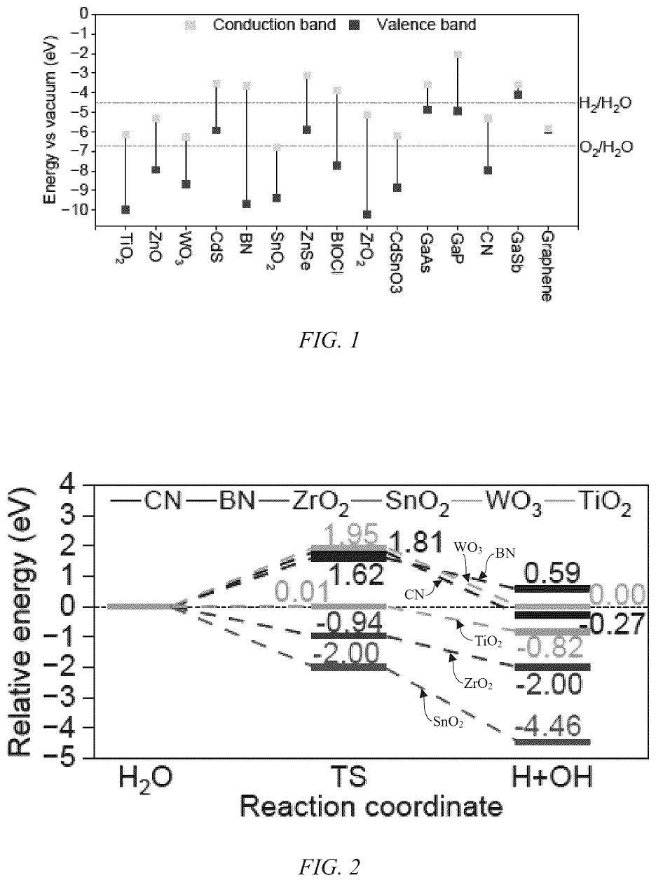

FIG. 1 depicts the ionization energy, electron affinity, and corresponding band gap against vacuum level of widely used semiconductor materials in photocatalysis applications. The free energy for water oxidation and hydrogen evolution reaction is plotted as well to facilitate the comparison between semiconductors. The band gap is a critical property in semiconductor materials, representing the energy difference between the valence band and conduction band. This figure facilitates the selection of semiconductor pairs for constructing heterostructures. Plotting the band gaps against the vacuum level can provide insights into the absolute positions of the conduction and valence bands, which is critical for designing heterostructures capable of efficient charge separation. Semiconductor materials with lower band gaps typically exhibit electron-hole separation, however, their efficiency in photocatalysis is limited by high charge recombination rates. Conversely, large band gap semiconductors require high-energy light (UV) to excite valence electrons. However, these materials can demonstrate improved charge separation upon excitation with high-energy light, enabling prolonged electron and hole interaction with the target contaminants.

FIG. 1, illustrates the band energy difference between conduction and valence bands relative to vacuum level across different semiconductors. FIG. 1 features a horizontal dotted line showing redox potential for hydrogen evolution and water oxidation. Electron affinity and ionization potential of semiconductors influence their ability to generate reactive oxygen species, which are crucial for PFAS degradation. The performance of semiconductor materials can be enhanced by tuning the band gaps to enable effective photocatalysis under low-energy light, such as visible light. Fabricating heterostructures with complementary materials can address the inherent limitations of individual semiconductors. Semiconductors with conduction band minima closer to the vacuum level exhibit lower electron affinity, while those with valence band maxima farther from the vacuum level display higher ionization potentials. This information is essential for designing heterostructures tailored to specific contaminants.

Since a semiconductor material that can accept electrons is required for PFAS degradation, materials with higher electron affinity and higher ionization potential were targeted. As presented in FIG. 1, semiconductors such as boron nitride (BN), zirconium oxide (ZrO₂), titanium dioxide (TiO₂), stannic oxide (SnO₂), and cadmium metastannate (CdSnO₃) possess moderate electron affinity and high ionization potential. Furthermore, vacancies of electronegative atoms in the crystal structure of these materials create regions of high positive charge due to their elevated ionization energy. These positively charged sites can attract PFAS anions and potentially facilitate their degradation. Additionally, the lower valence band minima of these materials can enhance water oxidation, leading to the generation of hydroxyl (OH) free radicals. These radicals can degrade PFAS by removing carboxyl or sulfonic acid groups, thereby producing PFAS free radicals. It is important to note that materials such as cadmium sulfide (CdS), silver iodide (AgI), zinc selenide (ZnSe), gallium arsenide (GaAs), gallium antimonide (GaSb), and gallium phosphide (GaP) are effective for hydrogen evolution reactions due to their ability to readily donate electrons. However, their use in heterostructure design is less relevant in this context. Since PFAS degradation is predominantly driven by hole oxidation, the invention focuses on heterostructures that enhance hole density. Consequently, materials such as TiO₂, ZrO₂, SnO₂, and CdSnO₃ are more suitable for promoting PFAS degradation.

FIG. 2 illustrates the energy landscape associated with free radical generation during water splitting on semiconductor photocatalysts. Semiconductor materials absorb photons from visible or UV light, resulting in the excitation of electrons from the valence band to the conduction band. This excitation leads to the separation of charge carriers, whereby electrons move to the conduction band and holes to the valence band. In the presence of water, holes in the valence band react with water molecules to produce hydroxyl radicals (·OH) and protons. Concurrently, the electrons in the conduction band facilitate the reduction of water to form hydrogen radicals (·H). These highly reactive free radicals play a crucial role in subsequent chemical processes, including PFAS degradation. The efficacy of this process depends on the properties of the semiconductor photocatalyst and its light absorption capabilities. Free radical generation is a critical factor in enhancing photocatalytic activity in addition to direct oxidation mechanisms. The x-axis of FIG. 2 represents the reaction states, while the y-axis depicts the relative energy. In the initial state, water molecules adsorb onto the surface of the semiconductor material. This is followed by the formation of a transition state in the second step, which ultimately breaks down to produce hydroxyl radicals in the final state. As depicted in FIG. 2, WO₃ exhibits a high free energy of 1.95 eV at the transition state and 0 eV at the final product. Positioned at 1.81 eV, CN shows high energy levels throughout the reaction coordinate, indicating its low potential for efficient free radical generation. In contrast, TiO₂, with a low energy of 0.01 eV at the transition state, emerges as a favorable material for free radical production. ZrO₂ and SnO₂ display the lowest energies, −0.94 eV and −2 eV, respectively, at the transition state, indicating that these materials encounter no energy barrier for completing the reaction. BN shows a high energy of 1.62 eV at the transition state but exhibits lower energy at the final product.

FIG. 2, illustrates the energy landscape for free radical generation from the initial reaction state (H₂O on the left-hand side of the figure represents adsorbed state of water) to the final reaction state (H+OH on the right-hand side of the figure represents adsorbed state of hydroxyl free radical) to indicate relative energy between different reaction states across 16 semiconductors, which include BN for boron nitride, CN for carbon nitride, WO₃ for tungsten trioxide, TiO₂ for titanium dioxide, SnO₂ for tin (II) oxide, and ZrO₂ for zirconium dioxide. The reaction coordinate energies were calculated following the Nudged Elastic Band (NEB) theory, which involves the optimization of a series of images representing the transition pathway between the initial and final states. According to the NEB method, the total energy of the system is calculated using Equation (1),

$${E}_{total} = {\sum }_{i = 1}^{N} {E}_{i} + \frac{1}{2} {\sum }_{i = 1}^{N 1} {k ( {r}_{i + 1} - {2}_{{r}_{i}} + {r}_{i - 1} )}^{2} \qquad ( 1 )$$

where Eₜₒₜₐₗ is the total energy of the pathway, Eᵢ is the energy of the i-th image, rᵢ is the position of the i-th image, k is the spring constant controlling the strength of the elastic band, and N is the total number of images. The first term in the equation represents the sum of the energies of all the images along the path, while the second term is a harmonic term that penalizes deviations of the images from a smooth pathway, effectively ensuring a smooth transition between the end states.

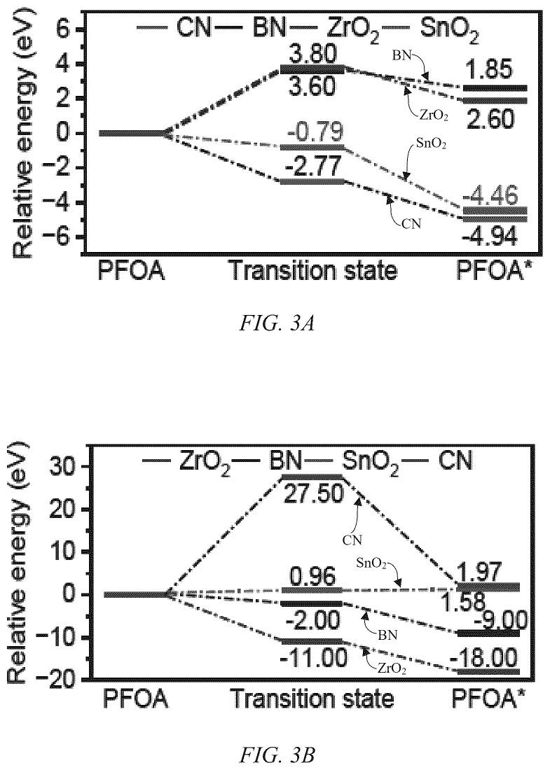

The differences in energy barriers associated with selected semiconductor materials for the decarboxylation, toward degradation, of perfluorooctanoic acid (PFOA), a widely investigated long-chain PFAS, are shown in FIG. 3A. The energy landscape of CN is represented by the lowest energy barrier of −2.77 eV, indicating a thermodynamically favorable reaction pathway. The final state energy of −4.94 eV confirms the effectiveness of CN in promoting PFOA decarboxylation. The energy barrier of ZrO₂ was recorded at 3.8 eV with the final state energy of 1.85 eV, implying that ZrO₂ does not promote decarboxylation. BN has a transition state energy of 3.6 eV, closely aligning with that of ZrO₂, indicating that BN is thermodynamically less favored to result in PFOA decarboxylation. Finally, although higher than that of CN, SnO₂ exhibits decarboxylation potential with a low energy barrier of −0.79 eV, as indicated by the final product energy of −4.46 eV. It is important to note that the efficiency of decarboxylation of PFOA is exclusive to other degradation mechanisms such as defluorination. Therefore, the efficacy of defluorination of PFAS by these semiconductors was studied separately prior to drawing further conclusions pertaining to PFAS destruction. The analysis of energy barrier for decarboxylation of PFOA is presented in FIG. 3B. The initial state represents PFOA adsorbing onto the geometrically optimized surface of semiconductors. The transition state corresponds to the formation of a PFOA intermediate product when interacting with the semiconductor surface. The final state is defined by the ejection of the first fluorine atom from the PFOA molecule. FIG. 3B illustrates the energy landscape for PFOA decarboxylation from the initial reaction state (PFOA on the left-hand side of the figure represents adsorbed state of PFOA) to the final reaction state (PFOA* on the right-hand side of the figure represents decarboxylated state of PFOA) to indicate relative energy between different reaction states across 4 semiconductors and energy landscape for PFOA defluorination from the initial reaction state (PFOA on the left-hand side of the figure represents adsorbed state of PFOA) to the final reaction state (PFOA* on the right-hand side of the figure represents defluorinated state of PFOA) to indicate relative energy between different reaction states across 4 semiconductors, thereby showing a strikingly contrasting scenario where BN and ZrO₂ exhibit effective defluorination potential, whereas CN demonstrates a high energy barrier of 27.5 eV. This observation confirms that defluorination and decarboxylation are mutually exclusive processes and must be studied with caution. The low transition state energies of −11 eV and −2 eV of ZrO₂ and BN, respectively, indicate the thermodynamically favorable reaction condition. However, ZrO₂ outperforms other semiconductor materials due to its high electron affinity. SnO₂ shows an energy barrier of 0.96 eV, which increases to 1.97 eV at the final state, indicating that SnO₂ is less favorable for the defluorination process. Nonetheless, SnO₂ demonstrates notable affinity for PFOA adsorption, consistent with its high electron affinity.

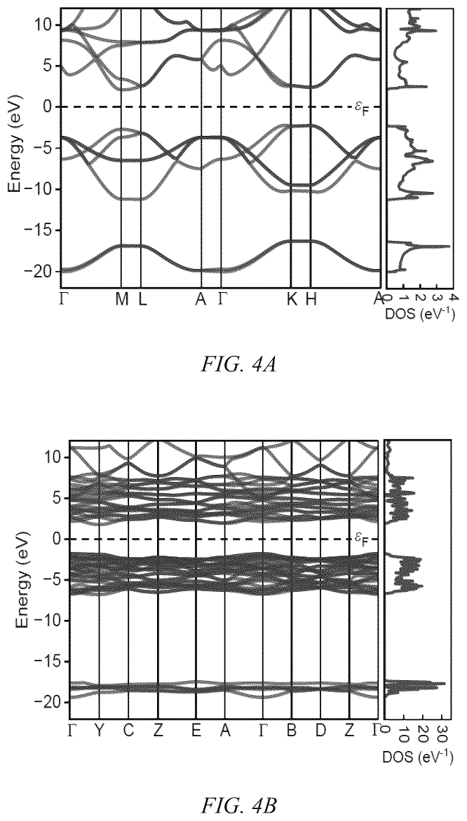

A novel semiconductor heterostructure and its mechanisms of action emerge from the TOPSIS analysis, which resulted in two promising semiconductor materials for constructing a heterostructure aimed at PFAS degradation. This heterostructure is composed of hexagonal boron nitride (h-BN) and zirconium dioxide (ZrO₂). h-BN is a 2D material with strong covalent bonds within its layers, resembling graphene in structure. It serves as an excellent supporting material due to its ability to form stable layered structures. ZrO₂ is a well-known oxide with a wide band gap, often used in photocatalysis due to its stability. As depicted in FIG. 4A and FIG. 4B, ZrO₂ exhibits a high density of states (DOS), particularly within its conduction band, whereas BN shows a low DOS, implying a lower electron availability. The elevated DOS of ZrO₂ suggests a greater availability of energy states for electron transition, making it a promising candidate for photocatalytic applications. Furthermore, its moderate band gap facilitates the excitation of valence band electrons, resulting in a high hole density during photoexcitation. In contrast, the wide band gap and low DOS of BN may limit its effectiveness in photocatalytic applications. This limitation can be addressed by incorporating ZrO₂ as a secondary semiconductor material in a heterostructure with BN. The favorable electronic properties of ZrO₂ can be effectively utilized to develop photocatalytic heterostructures for the degradation of PFAS. FIG. 4A illustrates that the band structure of h-BN reveals a wide direct band gap of 4.65 eV and indirect band gap of 4.30 eV while the Fermi level lies at −7.75 eV and density of states (DOS) shows a low dense electronic state corresponding to the bands. FIG. 4B illustrates that the band structure of ZrO₂ reveals the direct and indirect band gap of 3 eV with the Fermi level at −8 eV and the DOS plot shows a moderately dense electronic state. The results shown in FIG. 4A and FIG. 4B indicate that when combined, these two materials form a Type-II heterostructure with potential benefits in charge transfer and stability.

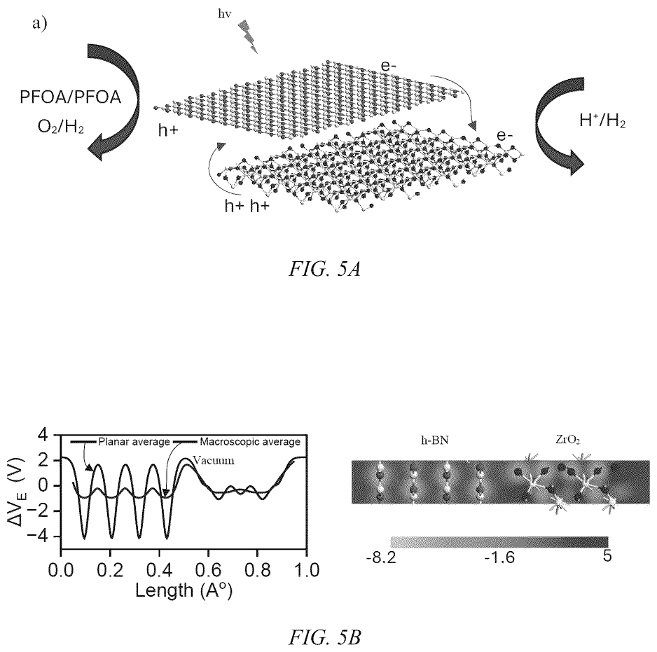

FIG. 5B depicts a plot of the potential energy difference (AVE) across the heterostructure. The electrostatic potential density difference, often referred to as the electrostatic potential map or difference density, is employed to visualize the variation in electrostatic potential around a molecule or a system. It is typically defined as the difference between the electrostatic potential due to a particular electronic density and a reference electrostatic potential (Equation (2)),

$$Δ V ( r ) = {V}_{total} ( r ) - {V}_{ref} ( r ) \qquad ( 2 )$$

where ΔV(r) is the electrostatic potential density difference at position r, Vₜₒₜₐₗ(r) is the electrostatic potential at position r due to the total electronic density of the system, and V_{ref}(r) is the electrostatic potential at position r due to a reference electronic density or a background charge. The electrostatic potential V(r) at a point r due to a charge density ρ(r) can be calculated using Equation (3),

$$V ( r ) = \frac{1}{4 {πϵ}_{0}} \int \frac{p ( {r}^{′} )}{\vert r - {r}^{′} \vert} {dr}^{′} \qquad ( 3 )$$

where ϵ₀, is the permittivity of free space and ρ(r′) is the charge density at position r′. FIG. 5A illustrates a Type-II heterostructure of h-BN and ZrO₂ that promotes electron and hole separation to facilitate PFAS degradation. FIG. 5B illustrates the electrostatic potential difference at the interface of two semiconductors. The labeled curves indicate the planar average electrostatic potential difference and macroscopic average potential difference respectively, which shows that the energy difference is crucial for understanding charge carrier behavior. While areas with positive AVE indicate regions where electron accumulation is promoted by the potential, negative AVE indicates regions of hole accumulation. The spatial variation in potential energy across the heterojunction drives the movement of photoexcited electrons and holes to different regions, reducing recombination and enhancing catalytic activity. There are two mechanisms associated with photocatalytic PFAS degradation involving highly reactive oxygen species (ROS) such as hydroxyl radicals (·OH) or superoxide free radicals (O₂·⁻), or direct hole oxidation. Both h-BN and ZrO₂ have lower valence band potentials compared to the water oxidation potential, which facilitates ROS generation. Additionally, the accumulated holes on the h-BN surface can enhance hole oxidation of PFAS. Thus, the combination of h-BN and ZrO₂ serves as a promising photocatalytic heterostructure aimed at PFAS degradation. The band gap of the semiconductor heterostructure reduces to 1.33 eV (a direct band gap obtained from Density Functional

Theory calculations), which is significantly lower than their individual band gaps. This reduced band gap presents a significant opportunity for its application in the photocatalytic degradation of contaminants under visible light. The resultant heterostructure exhibits a maximum absorption of 30,697 cm⁻¹ at an energy level of 1.76 eV, which lies within the visible range of the UV-VIS spectrum. This absorption characteristic is crucial for harnessing visible light effectively. The conduction band offset between h-BN and ZrO₂ facilitates efficient electron transfer, with ZrO₂ acting as an electron acceptor due to its lower conduction band minima compared to h-BN, and the valence band offset enabling hole transfer from ZrO₂ to h-BN. This efficient transfer of electrons and holes minimizes recombination, thereby enhancing the heterostructure's efficacy in driving photocatalytic reactions.

PFAS degradation mechanisms are complex, and conventional degradation processes including oxidation by ROS or free radicals have proven effective for some contaminants. However, their efficacy in degrading PFAS remains a topic of significant debate. Degradation mechanisms involving hydrated electrons, ROS, or free radicals are generally effective when the target contaminant possesses electrophilic sites. These species, which are rich in electrons, interact with electrophilic sites and facilitate the degradation process. In the case of PFAS, the hydrophobic tails containing electronegative fluorine atoms contribute to their recalcitrant behavior. Fluorine, being more electronegative than oxygen, is expected to act as an active site for nucleophilic attack. However, in practice, the functional groups of PFAS exhibit higher reactivity. This behavior can be explained by the frontier molecular orbitals and Fukui function, highlighting the specific sites susceptible to nucleophilic, electrophilic, and free radical attack.

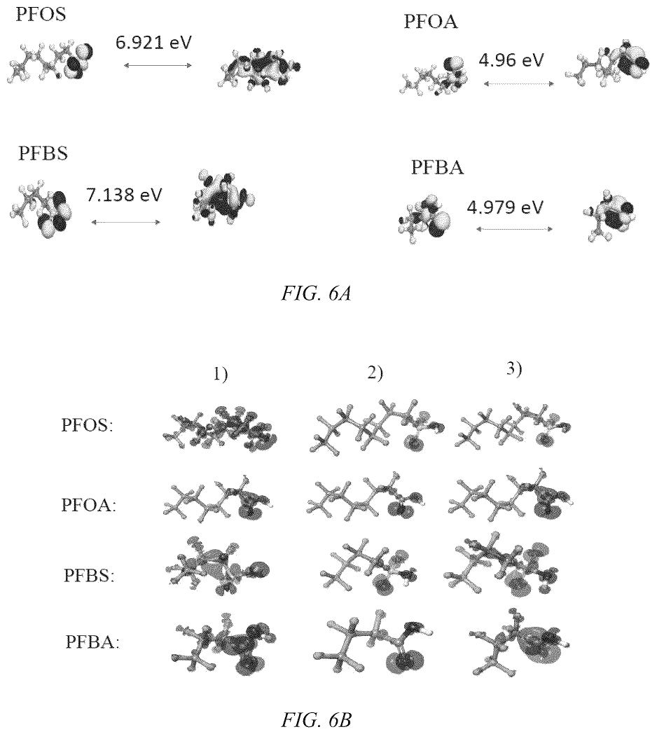

FIG. 6A illustrates a visualization of HOMO and LUMO orbitals. FIG. 6B illustrates a visualization of 1) nucleophilic Fukui function, f⁺(r) 2) electrophilic Fukui function, f⁻(r), and 3) free radical Fukui function, f⁰(r) for two long-chain PFAS (perfluorooctane sulfonic acid (PFOS) and PFOA) and two short-chain PFAS (perfluorobutane sulfonic acid (PFBS) and perfluorobutanoic acid (PFBA)), thereby showing that the active sites are mostly located in the functional groups of the tested PFAS. Therefore, even if the reaction becomes effective, PFAS degradation may remain energy intensive due to their hydrophobic tails being inactive.

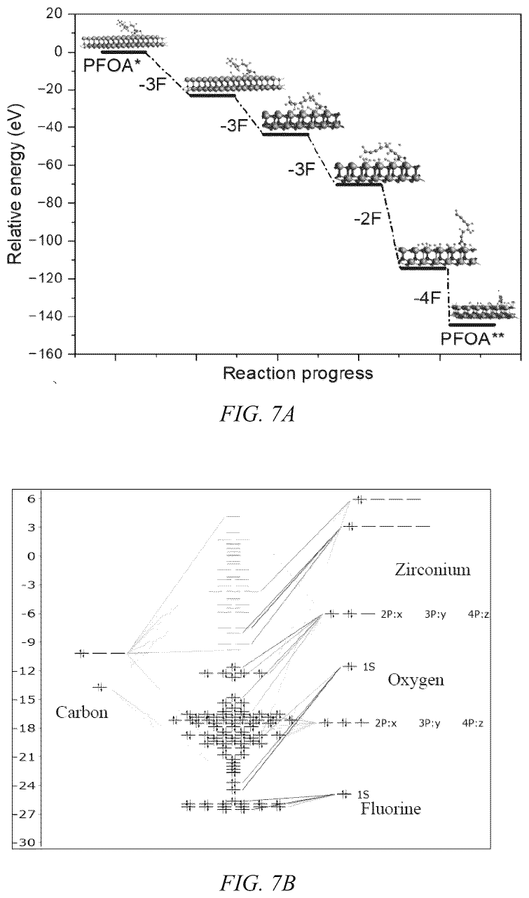

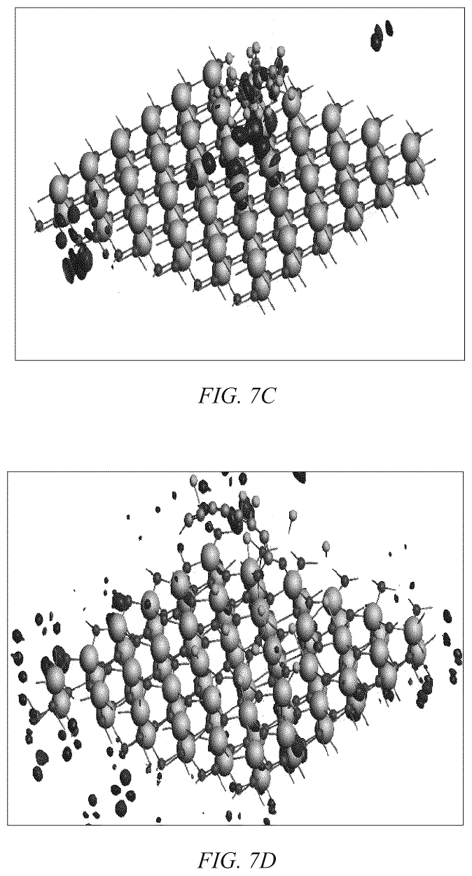

Complete defluorination of PFOA on the surface of ZrO₂, depicted against the negative energy, demonstrates the thermodynamic favorability, as shown in FIG. 7A. The inactivity of fluorine atoms of PFAS can be better understood by examining the molecular orbital of a PFOA molecule onto the ZrO₂ surface, as shown in FIG. 7B. The highest occupied molecular orbital (HOMO) is located in the oxygen atom, whereas the lowest unoccupied molecular orbital (LUMO) is located mostly in the Zr atom. The frontier molecular orbital configuration of PFAS shows that the HOMO and LUMO orbitals are mostly located in the functional group and the nearest carbon atoms, respectively, as shown in FIG. 6A. While the energy gap between HOMO and LUMO is high for degradation under natural conditions, it is approximately 2 eV for a PFAS molecule on the ZrO₂ surface, as shown in FIG. 7B, implying a decreased energy requirement for PFAS degradation by the semiconductor photocatalyst. Since the HOMO is located on the oxygen atom, the excitation will result in the migration of electrons from the oxygen orbital to the Zr orbital. Because the oxygen 2p, 3p, and 4p orbitals can interact with the Zr d-orbitals, the functional group of a PFAS molecule is more likely to approach a solid surface during an adsorption process. Although oxygen atoms interact more actively with the semiconductor photocatalyst, this interaction does not facilitate the removal of functional groups. This can be attributed to the low HOMO-LUMO gap of carboxylic groups, where the two oxygen atoms in a carboxylic group can easily bind to the surface of the semiconductor. Such binding requires minimal energy exchange, leading to enhanced stability. In contrast, the removal of the sulfonic functional group of PFOS is comparatively easier than that of carboxylic groups. The 2px, 3py, and 4pz orbitals of fluorine atoms are positioned far below the HOMO, indicating that the defluorination process requires significant energy. Consequently, degrading PFAS molecules in aqueous matrices solely by energy application is highly energy intensive. Since adsorption reduces the energy requirement, the selection of semiconductor materials should prioritize adsorption capacity. A molecular dynamics simulation of PFOA adsorption on the surface of ZrO₂ is presented in FIG. 7A, illustrating the stepwise defluorination process. The adsorption of PFAS functional groups onto the ZrO₂ surface involves electron transfer from the oxygen atoms in the functional group to the vacant d-orbitals of Zr. This facilitates the subsequent transfer of electrons from the 2px, 3py, and 4pz orbitals of fluorine atoms to the Zr orbitals. Furthermore, the 7p, 8p, and 9p orbitals of Zr can participate in the defluorination process. The molecular orbital diagram of the complete defluorination process reveals hybridization between the p-orbitals of fluorine and the orbitals of Zr. It is evident that the d-and p-orbitals of Zr can accommodate the excited-state electrons from fluorine atoms, facilitating the defluorination process. FIG. 7C shows the accumulation of excited-state electrons from fluorine atoms on Zr atoms, while FIG. 7D illustrates the dispersed electron density over the ZrO₂ surface following the complete defluorination of PFOA.

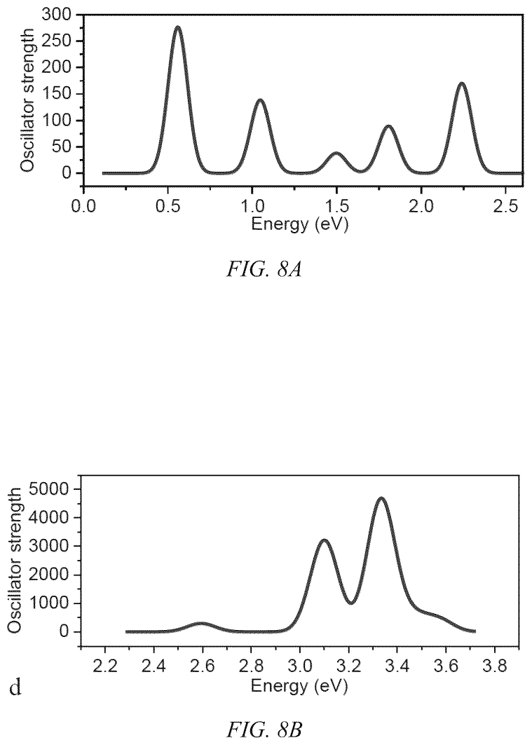

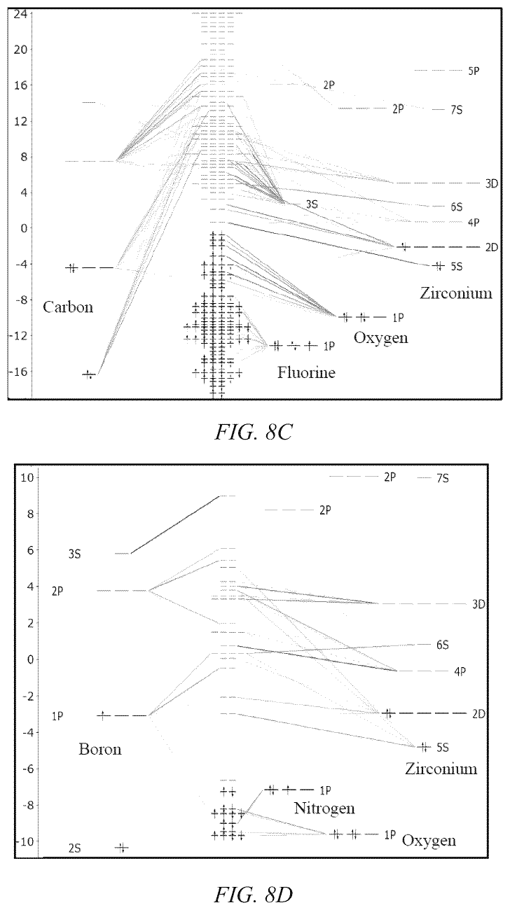

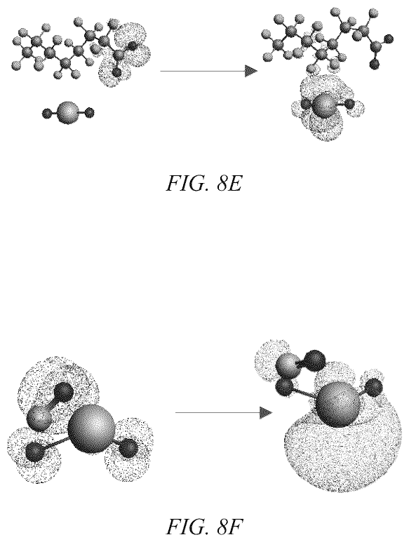

Feasibility of visible light for the photocatalytic degradation of PFAS by hBN/ZrO₂ heterostructure was investigated further. The potential of hBN/ZrO₂ for the degradation of PFAS under ambient environmental conditions was demonstrated in the previous section. The impact of light absorption upon the excitation of the hBN/ZrO₂ heterostructure was studied further, as shown in FIG. 8. The HOMO orbital of ZrO₂ is typically located on the oxygen atom, whereas the LUMO orbital is located on the Zr atom. Hence, the excitation of a ZrO₂ crystal primarily leads to the migration of electrons from the oxygen atom to that of Zr. This migration can facilitate the reduction of electrostatic charge on the oxygen atom, leading to the adsorption of PFAS. However, this process cannot guarantee the interaction of the fluorine atom with the vacant orbital of Zr. In addition, the energy required for the electrons to migrate from the fluorine orbital to the vacant Zr orbital is high. While visible light absorption by ZrO₂ is not adequate to facilitate this migration directly, the adsorption of PFAS onto the ZrO₂ surface can still lead to defluorination, as demonstrated by the molecular dynamics simulation presented in the previous section. The integration of BN with ZrO₂ improves the absorption of visible light, as indicated by the markedly enhanced oscillator strength, from less than 300 to 4684 (maximum oscillator strength) in FIG. 7A and FIG. 7B following the incorporation of BN. This excitation can help the N orbital electron to migrate to the vacant Zr and B orbitals, leading to the reduction of possible electrostatic repulsion of BN against a PFAS molecule. Thus, the integration of BN with ZrO₂ can improve the adsorption capacity of BN, which in turn facilitates the defluorination process.

The h-BN/ZrO₂ heterostructure demonstrates a significant enhancement in visible light absorption compared to its individual components, as evidenced by TD-DFT-calculated UV-vis absorption spectra and oscillator strength profiles. While both h-BN and ZrO₂ are wide-band gap semiconductors with absorption edges below 250 nm, their coupling gives rise to new interfacial electronic transitions with substantially higher oscillator strengths in the 400-600 nm range, effectively red-shifting the absorption onset into the visible region.

Oscillator strength, which quantifies the probability and intensity of electronic transitions, reaches values up to 3000 near 3.1 eV (400 nm) in the heterostructure highlighting strong photon absorption in the visible spectrum. These transitions originate from interfacial orbital hybridization, forming a Type-II band alignment that facilitates low-energy excitations across the interface. This optical improvement markedly increases overlap with the solar spectrum over 45% of which lies between 400 and 700 nm. In contrast to pristine h-BN or ZrO₂, which absorb less than 5% of solar flux due to UV-only activity, the heterostructure effectively utilizes visible light. For comparison, anatase TiO₂ absorbs primarily UV light with an onset at ~385 nm (~3.2 eV), while g-C3N4 extends to 450 nm but suffers from low oxidative potential (VB~+1.3 V vs NHE), limiting PFAS degradation.

The h-BN/ZrO₂ system overcomes these limitations by combining enhanced visible-light absorption, strong oscillator strength, and a deep valence band edge, making it particularly well-suited for visible-light-driven PFAS defluorination. The staggered band configuration promotes spatial separation of charge carriers, reducing recombination losses, while interfacial transitions enable efficient photon absorption and charge generation collectively translating into improved solar photocatalytic performance.

FIG. 8A illustrates the UV-VIS absorption spectra of ZrO₂ shows low absorption of visible light. FIG. 8B illustrates the UV-VIS absorption spectra of ZrO₂/BN heterostructure, which shows improved absorption of visible light due to the coupling of N atom. FIG. 8C illustrates the molecular orbital structure of PFOA molecule with a bulk ZrO₂ molecule, which shows the relative position of each orbital against energy along with the contribution of each atomic orbital towards the molecular orbital hybridization (The use of crystal structure was avoided to reduce computational cost), FIG. 8D illustrates the molecular orbital diagram of ZrO₂/BN heterostructure (Only the bulk molecular configuration was used to avoid high computational cost). FIG. 8E illustrates the transfer of electron density from HOMO (34 A) orbital to LUMO (35 A). The HOMO orbital is located on the oxygen atom of PFOA and the LUMO orbital is located on the Zr atom. FIG. 8F illustrates the transfer of electron density from the HOMO orbital (located on the N atom of BN) to the LUMO orbital (located on the Zr atom) of the ZrO₂/BN heterostructure, which underscores the promise of using advanced semiconductor heterostructures as an effective strategy for addressing the challenges associated with PFAS contamination.

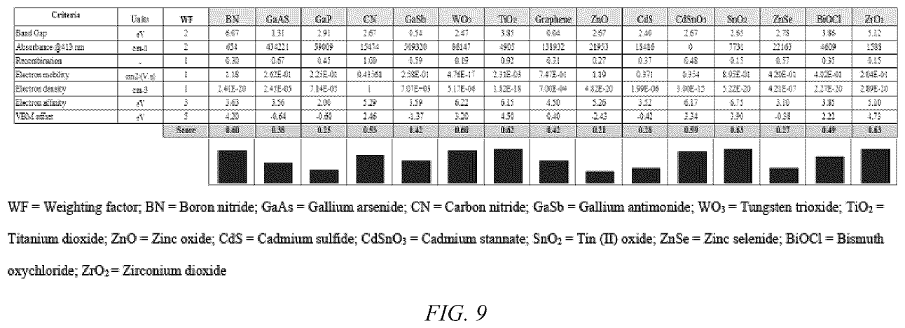

The table in FIG. 9 presents a comprehensive analysis of semiconductor materials evaluated for photocatalytic PFAS degradation. The selection process involved a multicriteria decision-making (MCDM) approach, specifically the Technique for Order Preference by Similarity to Ideal Solution (TOPSIS), to rank semiconductors based on their electronic and optical properties. The criteria considered include bandgap energy, absorbance at 413 nm, charge recombination rate, electron mobility, electron density, electron affinity, and valence band maximum (VBM) offset. These parameters were assigned weighting factors based on their significance in determining the efficiency of photocatalytic degradation under visible light.

The bandgap energy is a critical factor influencing the absorption of visible light, with materials having moderate bandgaps (~2-5 eV) being preferred for photocatalysis. The absorbance at 413 nm quantifies the material's ability to absorb visible light, which is essential for efficient photocatalytic activation. Charge recombination rate directly affects the persistence of photogenerated electron-hole pairs, with lower recombination rates correlating to higher quantum efficiencies. Electron mobility and electron density play a crucial role in charge transport and redox reactions at the semiconductor surface, while electron affinity determines how effectively the material can facilitate charge transfer. Finally, the VBM offset is essential for enabling effective hole oxidation, which is a dominant mechanism in PFAS degradation.

From the rankings, boron nitride (BN), zirconium dioxide (ZrO₂), tin dioxide (SnO₂), and titanium dioxide (TiO₂) emerged as the top-performing materials due to their moderate bandgaps, high electron affinity, and favorable VBM offsets. These properties enhance visible-light absorption, charge separation, and ROS generation, making them ideal candidates for semiconductor heterostructures. The selected h-BN/ZrO₂ heterostructure effectively leverages the complementary properties of these materials to achieve superior photocatalytic performance.

The present invention demonstrates that semiconductor heterostructures can significantly improve the photocatalytic degradation of PFAS by optimizing charge separation and reducing recombination losses, thereby enhancing the generation of reactive species and leading to more efficient degradation of persistent pollutants. The study confirms that visible light is a feasible energy source for driving photocatalytic reactions in semiconductor heterostructures, leveraging a broader spectrum of solar energy and making the technology more practical and sustainable for real-world applications. The analysis further reveals that hole oxidation is the predominant mechanism in the photocatalytic degradation of PFAS when using semiconductor heterostructures, attributable to the effective transfer and accumulation of holes in the heterostructure.

Methods involved in the ranking process for selecting and optimizing semiconductor photocatalysts begin by gathering potential semiconductor photocatalyst candidates from literature. These materials are then subjected to a multi-step screening and analysis process. In the first screening step, the candidates were evaluated based on theoretical quantitative criteria such as band gap, UV-VIS spectra, electron density, electron mobility, and recombination rates. This step allows for an initial filtering of materials based on their theoretical potential. Following the theoretical intrinsic screening, TOPSIS analysis is conducted to further refine the selection. This includes performing a multicollinearity analysis and calculating variance inflation factors to eliminate correlated criteria. The results help in selecting the best-performing semiconductor photocatalyst and optimizing its heterostructure with a second semiconductor material. After identifying the top semiconductor, further DFT studies are performed on possible heterostructures. This includes molecular dynamics simulations and evaluating the PFAS degradation efficiency to single out two optimal heterostructures. The deconvolution of the molecular orbitals of both the heterostructure and the PFAS molecule is also performed to investigate their interaction under visible light.

In the aforementioned detailed description of the present invention, reference is made to the accompanying drawings, which form a part thereof, and within which are shown by way of illustration specific embodiments by which the invention may be practiced. Numerous specific details are set forth to provide a thorough description of the embodiments of the present invention. It will be apparent to one of ordinary skill in the art that some embodiments may be practiced without some of these specific details. It is to be understood that other embodiments may be utilized, and structural changes may be made without departing from the scope of the invention.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

All numerical designations, such as measurements, efficacies, physical characteristics, forces, and other designations, including ranges, are approximations which are varied up or down by increments of 1.0 or 0.1, as appropriate. It is to be understood, even if it is not always explicitly stated that all numerical designations are preceded by the term “approximately.” As used herein, “approximately” refers to being within an acceptable error range for the particular value as determined by one of ordinary skill in the art, which will depend in part on how the value is measured or determined. When an acceptable range is not dictated by the one of ordinary skill in the art, “approximately” refers to +15% of the numerical when used in connection with particular values; it should be understood that a numerical including an associated range with a lower boundary of greater than zero must be a non-zero numerical, and the term “approximately” should be understood to include only non-zero values in such scenarios.

The phrases “in some embodiments,” “according to some embodiments,” “in the embodiments shown,” “in other embodiments,” and the like generally mean the particular feature, structure, or characteristic following the phrase is included in at least one implementation. In addition, such phrases do not necessarily refer to the same embodiments or different embodiments.

### GLOSSARY OF CLAIM TERMS

Adsorption means the adhesion or accumulation of atoms, ions, or molecules from a fluid (liquid or gas) onto the surface of a solid material. In the context of this invention, adsorption refers to the attachment of PFAS molecules, including their functional groups, onto the active sites of a semiconductor material such as ZrO₂ or h-BN. This process can be critical in photocatalytic degradation because it brings the PFAS molecules into close proximity with the catalyst's reactive sites, thus reducing the energy required to break specific chemical bonds. Unlike absorption, which involves the penetration of substances throughout a material's bulk, adsorption primarily occurs at the surface or interface. Enhancing adsorption capacity in a photocatalyst can lower activation barriers for defluorination or decarboxylation, making the overall PFAS degradation process more energy-efficient and effective. In particular, semiconductor materials that exhibit high electron affinity or particular surface morphologies may facilitate stronger electrostatic attraction, thereby increasing adsorption of PFAS molecules.

Band gap means the energy difference between the valence band and the conduction band in a semiconductor material. In this invention, the band gap determines the wavelength of light that can be absorbed to generate electron-hole pairs for photocatalytic reactions. A large band gap, such as in typical oxides like ZrO₂, requires higher-energy photons (often in the ultraviolet range), while a narrower band gap allows absorption of lower-energy photons in the visible spectrum. Controlling the band gap is central to designing an efficient photocatalyst capable of degrading PFAS under visible light rather than relying on UV sources. By stacking different semiconductor materials, it is possible to tune the effective band gap, thereby expanding the range of electromagnetic radiation usable for driving photocatalytic degradation processes.

Band offset means the relative difference in energy levels (conduction band or valence band) between two semiconductor materials when they form a heterojunction. In this invention, a favorable band offset is crucial to achieving efficient charge separation and minimal recombination. When two semiconductors with properly aligned band edges are combined, the electrons tend to flow into the lower-energy conduction band region, and holes migrate into the higher-energy valence band region. This separation effectively prolongs the lifetime of the charge carriers, enabling them to participate in redox reactions that break down PFAS. By carefully engineering the band offset, the invention can harness visible light more effectively and direct electron-hole pairs toward the degradation pathways for defluorination and decarboxylation.

Boron nitride (BN or h-BN) means a two-dimensional material composed of alternating boron and nitrogen atoms arranged in a hexagonal lattice. In this invention, h-BN is used primarily for its wide band gap, high chemical stability, and layered structure reminiscent of graphene. Although h-BN itself does not absorb a broad range of visible light, it serves as a complementary semiconductor in heterostructure designs. By combining h-BN with materials like ZrO₂, the invention can reduce the effective band gap and promote better charge separation. In addition, h-BN has desirable surface properties that facilitate the adsorption of PFAS, particularly under conditions where hole oxidation is a predominant reaction mechanism. Its unique electronic and structural characteristics enable the formation of stable heterointerfaces, where electrons and holes can migrate efficiently.

Charge recombination means the process by which photogenerated electrons and holes annihilate each other before participating in a desired chemical reaction. In this invention, charge recombination is a key bottleneck that limits photocatalytic efficiency in PFAS degradation. When a semiconductor photocatalyst is illuminated, electrons transition from the valence band to the conduction band, leaving behind holes in the valence band. If these electrons and holes recombine quickly, they cannot effectively engage in redox processes that degrade PFAS molecules. Designing heterostructures with strategically aligned band edges helps minimize charge recombination by promoting spatial separation of electrons and holes. Reducing charge recombination enhances the overall quantum efficiency of the process, thereby facilitating more rapid and complete breakdown of the carbon-fluorine bonds in PFAS.

Charge separation means the effective spatial or energetic separation of photoexcited electrons and holes in a semiconductor system. In this invention, achieving robust charge separation is crucial for driving the redox reactions that break down PFAS. When a semiconductor absorbs photons, electrons are excited to higher energy states, leaving behind positively charged holes. Without adequate design considerations, these charges can quickly recombine. However, in a properly engineered heterostructure, electrons and holes become separated into different layers or regions based on band alignment. This means that electrons migrate to one semiconductor layer (usually the one with lower conduction band energy), and holes migrate to the other (usually with a higher valence band energy). By keeping charges apart, the invention ensures they remain available for PFAS oxidation and reduction reactions, thus boosting the catalyst's overall efficiency.

Decarboxylation means the process of removing a carboxyl group (—COOH) from an organic compound, often resulting in the release of carbon dioxide (CO₂). In the context of this invention, some PFAS, such as perfluorooctanoic acid (PFOA), contain a carboxylic functional group that can be cleaved during photocatalytic degradation. Decarboxylation can be one of several possible pathways by which these pollutants break down on semiconductor surfaces. However, the invention specifically focuses on enhancing defluorination over decarboxylation, given that cleaving the fluorinated carbon chain is essential to fully neutralize PFAS toxicity. While decarboxylation may reduce the carbon chain length, it does not always address the core issue of persistent fluorinated bonds. Therefore, decarboxylation is considered a partial degradation step that may precede, but should not replace, more critical defluorination mechanisms.

Defluorination means the removal of fluorine atoms from a chemical compound, particularly from per-and polyfluoroalkyl substances. In this invention, defluorination is a vital step for truly degrading PFAS, because the carbon-fluorine bond is one of the strongest and most chemically resistant bonds in organic chemistry. By breaking these bonds, the invention ensures the formation of less harmful or non-toxic byproducts, such as fluoride ions, CO₂, and simpler organics. Semiconductor heterostructures designed here aim to facilitate defluorination by providing favorable band positions, electron affinities, and surface sites that attract and destabilize the C—F linkage. Defluorination may proceed via direct hole oxidation, radical-mediated reactions, or a combination of both, depending on how the excited charges and reactive species localize at the catalyst's surface.

Density functional theory (DFT) means a quantum mechanical computational method used to investigate the electronic structure of atoms, molecules, and solids. In this invention, DFT helps model the semiconductor materials at the atomic level to predict band structures, density of states, and orbital interactions relevant for PFAS degradation. Using DFT, researchers can identify how specific changes in material composition or crystallographic arrangement alter the photocatalyst's electronic properties and reactivity. These insights are essential in designing and optimizing heterostructures that can capture visible light effectively and drive defluorination with high efficiency. DFT calculations also guide the selection of suitable dopants or layer configurations, thereby reducing empirical trial-and-error and accelerating the development of advanced photocatalytic materials.

Electron-hole pairs means the electron in the conduction band and the corresponding hole in the valence band that arise when a semiconductor material absorbs a photon with sufficient energy to promote an electron across the band gap. In the context of this invention, these pairs are the primary agents for initiating redox reactions that degrade PFAS. Electrons can reduce certain species, while holes oxidize the pollutant molecules directly or indirectly via reactive oxygen species. Maximizing the generation and lifetime of electron-hole pairs is paramount to achieving high photocatalytic efficiency. Designing heterostructures with strategic band alignments prolongs the life of these pairs by reducing recombination, ultimately enabling more complete mineralization of PFAS contaminants.

Electrostatic potential difference means the spatial variation in electrostatic potential across a system or interface. In this invention, it typically refers to the difference in electric potential between two semiconductor materials in a heterostructure, such as h-BN and ZrO₂. This difference, often visualized in electrostatic potential maps, helps determine where electrons or holes tend to accumulate once photoexcitation occurs. By mapping how potential changes across the interface, researchers can predict charge migration pathways and evaluate the likelihood of recombination events. Controlling electrostatic potential differences through doping or structural modification can enhance the driving force for electron or hole transfer, thereby improving the heterostructure's capacity for PFAS degradation via defluorination or other relevant reactions.

Foam fractionation means a separation technique where surfactants or other surface-active agents create stable foam structures that enrich certain chemical species at the gas-liquid interface. In this invention, foam fractionation can serve as a preliminary PFAS removal step, concentrating the pollutants before they undergo photocatalytic treatment. PFAS, known for their surfactant-like properties, can be selectively captured in the foam phase, effectively reducing the volume of contaminated water. Although foam fractionation does not itself destroy PFAS, it can be integrated into a broader treatment sequence. Once PFAS are concentrated, they can be directed to the semiconductor heterostructure reactor, where the focus is on defluorination and complete mineralization. Combining foam fractionation with photocatalysis thus addresses both removal and destruction goals.

Heterojunction means a junction formed between two dissimilar semiconductor materials having distinct band structures. In this invention, the formation of a heterojunction is essential for achieving the desired photocatalytic properties that enhance PFAS degradation. When two materials with different conduction and valence band edges come into contact, electrons and holes may preferentially migrate to separate regions, thus prolonging their lifetimes and making them more available for redox reactions. This separation is particularly important in the defluorination process, where high-energy holes can oxidize the strong C—F bonds. A well-designed heterojunction also broadens the spectrum of light absorption, allowing the system to utilize visible light more efficiently. Consequently, heterojunctions are key to improving both the activity and stability of semiconductor-based photocatalysts.

Heterostructure means a composite material made from layering or stacking two or more semiconductors with different electronic or structural characteristics. In this invention, heterostructures such as h-BN/ZrO₂ are employed to enhance photocatalytic performance against PFAS. By carefully combining materials with complementary band alignments, the invention can extend light absorption into the visible range, reduce charge-carrier recombination, and concentrate electron-hole pairs at specific interfaces conducive to defluorination. Heterostructures can be built with varying degrees of complexity, involving multiple layers, doping agents, or nanostructured morphologies. Each layer contributes specific properties-such as band offset, charge mobility, or adsorption capacity-allowing the overall system to attack the persistent carbon-fluorine bonds in PFAS more effectively.

Ion exchange means a process in which ions are swapped between a solution and a solid substrate (commonly a resin) with binding sites for specific ions. In this invention, ion exchange can be employed to remove charged PFAS species from contaminated water, concentrating them onto a solid medium. While ion exchange is effective at separating PFAS from large volumes of water, it does not break carbon-fluorine bonds. Therefore, the invention contemplates coupling ion exchange with advanced photocatalytic degradation to ultimately destroy PFAS. After the ion exchange process, the concentrated waste stream containing high levels of PFAS can be introduced to the semiconductor heterostructure reactor. This approach facilitates both capture and subsequent destruction of PFAS, minimizing overall waste and environmental risk.

Oxidation potential means the tendency of a species, including photoexcited holes, to oxidize another chemical entity. In semiconductor photocatalysis, oxidation potential is linked to the position of the valence band relative to the electrochemical potentials of various reactions. A valence band situated at a more positive potential can effectively remove electrons from robust chemical bonds like those in PFAS. In this invention, materials are chosen and paired based on their oxidation potentials, ensuring that holes generated upon illumination can cleave C—F bonds. A high oxidation potential can drive the formation of reactive oxygen species or directly oxidize PFAS molecules, thus facilitating decarboxylation or defluorination. Careful engineering of band structures and doping can tailor the oxidation potential for optimal PFAS destruction.

Per-and polyfluoroalkyl substances (PFAS) means a class of synthetic chemicals characterized by multiple carbon-fluorine bonds, which are highly stable and resistant to conventional degradation methods. Examples include perfluorooctanoic acid (PFOA) and perfluorooctane sulfonic acid (PFOS). In this invention, PFAS contamination is addressed by semiconductor heterostructures that utilize visible-light photocatalysis to break these tough bonds. PFAS are notorious for environmental persistence, bioaccumulation, and potential toxicity, making their destruction rather than mere removal a priority. The invention seeks to cleave C—F bonds, converting PFAS into fluoride ions, carbon dioxide, and other benign byproducts. Because PFAS compounds exhibit hydrophobic tails and strong electronegativity, specialized catalyst design and band alignment are required to achieve efficient defluorination.

Photocatalyst means a substance capable of absorbing photons to produce chemical transformations without undergoing permanent chemical change itself. In this invention, photocatalysts are typically semiconductor materials or heterostructures designed to harness visible light for PFAS degradation. Upon absorbing photons, the photocatalyst generates electron-hole pairs that migrate to the catalyst's surface. These charges can then participate in oxidation or reduction reactions, ultimately breaking carbon-fluorine bonds. An effective photocatalyst must balance light absorption, charge mobility, low recombination rates, and stability under operational conditions. By altering composition, doping level, particle size, or surface structure, researchers can tailor the photocatalyst's activity and specificity, thereby making it more suitable for PFAS treatment applications.

Photocatalytic degradation means the process of using photoexcited semiconductors to initiate chemical breakdown of pollutants. In this invention, photocatalytic degradation specifically targets the destruction of PFAS molecules. When illuminated by visible light, semiconductor heterostructures generate reactive electrons and holes, which either directly or indirectly oxidize the PFAS via radical species. This leads to the eventual cleavage of the C—F bonds and the formation of less harmful end products. Photocatalytic degradation offers an advantage over techniques that merely transfer or concentrate PFAS by aiming for complete mineralization. Designing heterostructures that enhance light absorption, maintain high charge separation, and support PFAS adsorption is central to achieving efficient and cost-effective photocatalytic degradation.

Quantum virtual laboratory (QVL) means a computational framework that integrates quantum chemical calculations, such as density functional theory, with simulation tools and design optimization algorithms. In this invention, a QVL approach is used to identify, evaluate, and rank potential semiconductor materials or heterostructures before experimental validation. This allows for rapid screening of multiple candidate materials based on criteria like band gaps, electron affinity, recombination rates, and others essential for PFAS degradation. By leveraging QVL, the invention reduces the time and cost of trial-and-error experiments and provides insights into the molecular and electronic interactions governing photocatalytic reactions. The QVL thus guides the strategic selection of heterostructure compositions that are most likely to succeed in destroying PFAS under visible light.

Reactive oxygen species (ROS) means highly reactive oxygen-derived intermediates such as hydroxyl radicals (·OH), superoxide anions (O₂·-), and hydrogen peroxide (H₂O₂). In this invention, ROS can form when photogenerated electrons or holes in the semiconductor heterostructure react with water or dissolved oxygen. ROS are capable of oxidizing a wide range of contaminants, including partially oxidizing or fragmenting PFAS molecules. While direct hole oxidation can lead to defluorination, ROS-based pathways may facilitate additional or complementary degradation steps. Nonetheless, the use of ROS alone can be insufficient for complete PFAS mineralization if the system does not adequately address the C—F bond. Thus, the invention relies on both direct hole oxidation and ROS production to achieve enhanced photocatalytic efficiency.

Visible-light absorption means the capacity of a photocatalyst to absorb photons in the approximate wavelength range of 400 to 700 nanometers. In this invention, leveraging visible-light absorption is critical for lowering operational costs, as it potentially eliminates the need for specialized UV light sources. Semiconductor materials with too wide a band gap may only be activated by high-energy UV photons, limiting their practicality. By designing heterostructures or doping semiconductors, the invention shifts absorption into the visible region. This approach harnesses ambient light or more economical LED sources, making the PFAS degradation process more energy-efficient.

Optimal visible-light absorption involves balancing band gap energy, doping strategies, and structural modifications so that enough photons are absorbed to generate electron-hole pairs capable of cleaving stubborn PFAS bonds.

Zirconium dioxide (ZrO₂) means a metal oxide semiconductor commonly employed in photocatalysis due to its chemical stability, moderate band gap, and high electron affinity. In this invention, ZrO₂ forms a critical component of the heterostructure combined with h-BN to enhance PFAS degradation. ZrO₂ can absorb photons in the near UV to visible range and generate electron-hole pairs that participate in oxidation-reduction reactions. When paired with a complementary semiconductor, ZrO₂'s conduction band can facilitate efficient electron transfer, while its robust structure supports repeated operational cycles without significant degradation. ZrO₂ is especially noted for promoting defluorination processes because its valence and conduction bands allow holes and electrons to engage strong C—F bonds. By tuning synthesis parameters, doping, or morphological features, ZrO₂'s photocatalytic performance can be further optimized.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A semiconductor heterostructure comprising:
hexagonal boron nitride (h-BN); and
zirconium dioxide (ZrO₂), wherein the h-BN and the ZrO₂ form an interfacial heterostructure for photocatalytic degradation of per-and polyfluoroalkyl substances (PFAS) in an aqueous matrix under visible light.

2. The semiconductor heterostructure of claim 1, wherein a bandgap of the semiconductor heterostructure is approximately 1.33 eV, enabling absorption of the visible light.

3. The semiconductor heterostructure of claim 1, wherein the heterostructure comprises a Type-II band alignment.

4. The semiconductor heterostructure of claim 1, wherein the h-BN and ZrO₂ are layers arranged in a layered configuration for interfacial charge transfer.

5. The semiconductor heterostructure of claim 1, wherein the heterostructure is synthesized using a computational optimization approach including density functional theory (DFT) or quantum virtual laboratory (QVL) modeling.

6. The semiconductor heterostructure of claim 1, wherein the heterostructure exhibits an electron affinity of greater than about 6.5 eV, facilitating PFAS degradation through enhanced hole oxidation.

7. The semiconductor heterostructure of claim 1, further comprising one or more dopants.

8. An apparatus for photocatalytic degradation of per-and polyfluoroalkyl substances (PFAS), the apparatus comprising:
a semiconductor heterostructure comprising hexagonal boron nitride (h-BN) and zirconium dioxide (ZrO₂);
a reaction chamber configured to contain a PFAS-contaminated aqueous matrix and the semiconductor heterostructure; and
a visible-light source positioned to illuminate the semiconductor heterostructure within the reaction chamber.

9. The apparatus of claim 8, wherein the heterostructure comprises a Type-II band alignment.

10. The apparatus of claim 8, wherein the reaction chamber includes a circulation system to maintain uniform exposure of the PFAS-contaminated aqueous matrix to the heterostructure.

11. The apparatus of claim 1, further comprising a pre-treatment unit for concentrating PFAS from the PFAS-contaminated aqueous matrix before introduction into the reaction chamber.

12. The apparatus of claim 8, wherein the visible-light source operates within a wavelength range of about 400 nm to about 700 nm.

13. The apparatus of claim 8, further comprising a post-treatment filtration system to capture residual byproducts of the PFAS degradation.

14. A method for degrading per-and polyfluoroalkyl substances (PFAS) in an aqueous matrix, the method comprising:
introducing a semiconductor heterostructure composed of hexagonal boron nitride (h-BN) and zirconium dioxide (ZrO₂) into a PFAS-contaminated aqueous matrix; and
exposing the semiconductor heterostructure to visible light to perform photocatalytic degradation of the PFAS-contaminated aqueous matrix.

15. The method of claim 14, wherein exposing the semiconductor heterostructure to visible light facilitates redox reactions at an interface between the h-BN and the ZrO₂, producing reactive oxygen species (ROS) for PFAS degradation.

16. The method of claim 14, further comprising:
absorbing molecules of the PFAS into the semiconductor heterostructure;
defluorinating the PFAS molecules;
mineralizing the defluorinated PFAS molecules into non-toxic byproducts; and
removing the non-toxic byproducts from the aqueous matrix.

17. The method of claim 14, wherein the visible light source operates within the range of about 400 nm to about 700 nm.

18. The method of claim 14, wherein the semiconductor heterostructure is a Type-II heterojunction.

19. The method of claim 14, further comprising performing density functional theory (DFT) simulations and quantum virtual laboratory (QVL) modeling to optimize the semiconductor heterostructure design for PFAS degradation.

20. The method of claim 14, further comprising modifying a surface morphology of the semiconductor heterostructure for improved PFAS adsorption.
